(19) United States
(12) Patent Application Publication
(10) Pub. No.: US 2016/0151667 A1
(43) Pub. Date: Jun. 2, 2016

(54) MOVEMENT-ORBIT SENSING SYSTEM AND MOVEMENT-ORBIT COLLECTING METHOD USING THE SAME

(71) Applicants: INVENTEC (PUDONG) TECHNOLOGY CORPORATION, Shanghai (CN); INVENTEC CORPORATION, Taipei City (TW)

(72) Inventors: Chung-Sheng Ni, Taipei City (TW); Chih-Pin Wei, Taipei (TW); Chun-Ying Yang, Taipei City (TW)

(21) Appl. No.: 14/684,459

(22) Filed: Apr. 13, 2015

(30) Foreign Application Priority Data
Nov. 28, 2014 (CN) 201410708884.6

(51) Int. Cl. A63B 24/00; G01C 19/00; G01P 15/00

(52) U.S. Cl. CPC A63B 24/0021; G01P 15/00; G01C 19/00; A63B 2024/0025

(57) ABSTRACT

A movement-orbit sensing system is provided for collecting movement-orbits of sensing points of an object under detection, which comprises sensors, a host a comparison unit, and a determination unit. The sensors are used for outputting sensed signals and multi-dimensional coordinate value. The host comprises units for generating a multi-dimensional coordinate signal and sensed values, and a movement-obit architecture unit is used for architecting the movement-orbit of each sensing point according to the multi-dimensional coordinate signal and sensed values. The comparison unit is used for comparing the movement-orbit of the object under detection with a standard movement-orbit information, thereby obtaining an offset value. The determination unit is used for determining whether the offset value is greater than a preset value. If the offset value is greater than the preset value, the movement-orbit of at least one of the sensing points is determined to be erroneous.

### FIELD OF THE INVENTION

The present invention relates to a movement-orbit sensing system and a method using the same, and more particularly to a movement-orbit sensing system for collecting various types of physical quantities of an object under detection during exercise and a method using the same.

### BACKGROUND OF THE INVENTION

With the inter-combination of technology and exercise, various types of auxiliary equipment with respect to the exercises have been developed. A user can collect various types of data during exercise by using the auxiliary equipment. For example, ail of the coordinate values during exercise at a particular portion can be collected by using a signal collection unit, thereby obtaining a path during exercise at the particular portion.

In the prior art, one kind of auxiliary equipment needs to be disposed on an extensive space, and a plurality of cameras are disposed at different locations of the space. The movement of an athlete from each visual angle at each time point can be captured by using the cameras disposed at different locations. After capturing the needed images, a coordinate position at each time point of a particular portion of the athlete is analyzed by a computer, thereby obtaining a path of the particular portion. Obviously, the structure of this auxiliary equipment is complicated, and it will be restricted by space and location during use.

Furthermore, for some specific exercises, such as those focusing on rotation angle of the body or focusing on the force of a particular portion, if only the path of the exercise is obtained, a disadvantage of it is the lack of a reference value for a user.

Accordingly, it is necessary to provide a movement-orbit sensing system having a sample structure which will not be restricted by space and location. In addition, the movement-orbit sensing system cannot only obtain paths of a user during exercise, but can also obtain various types of physical quantities, such as rotation angle and force.

### SUMMARY OF THE INVENTION

To resolve the above technical problems, an objective of the present invention is to provide a movement-orbit sensing system, which has a simple structure and can be used for obtaining movement-orbits including paths, rotation angles, and force of an object under detection. Also, in the movement-orbit sensing system of the present invention, standard movement-orbit information is pre-set up, so as to analyze whether the current movement orbit is correct.

To achieve the above-mentioned inventive objective, the present invention provides a movement-orbit sensing system for collecting movement-orbits of a plurality of sensing points of an object under detection, comprising: a plurality of sensors for sensing the plurality of sensing points and correspondingly outputting a plurality of sensed signals and a plurality of multi-dimensional coordinate values; a host connected with the plurality of sensors, comprising: a detection unit for receiving the plurality of multi-dimensional coordinate values of the plurality of sensors and correspondingly generating a multi-dimensional coordinate signal; an analysis unit for receiving and quantizing the plurality of sensed signals to generate a plurality of sensed values; and a movement-orbit architecture unit for architecting the movement-orbit of each sensing point according to the multi-dimensional coordinate signal and the sensed values to corresponding to each sensing point of the object under detection; and an electronic device connected with the host, comprising; a standard database having at least one standard movement-orbit information; a comparison unit for comparing the movement-orbit of each sensing point of the object under detection with the standard movement-orbit information of the standard database, so as to obtain an offset value; and a determination unit for determining whether the offset value obtained by the comparison unit is greater than a preset value, where if the offset value is grater than the preset value, the determination unit determines the movement-orbit of at least one of the sensing points is erroneous, thereby outputting an error signal.

In a preferable embodiment of the present invention, the host further comprises a positioning unit for obtaining absolute position information of the host and an initial relative coordinate value between each sensor and the host; and the detection unit correspondingly generates the multi-dimensional coordinate signal according to the plurality of multi-dimensional coordinate values and the initial relative coordinate value of each sensor.

In a preferable embodiment of the present invention, the plurality of sensors comprise a gyroscope sensor and an acceleration sensor, and the sensed signals comprise a rotation angle signal and an acceleration signal.

In a preferable embodiment of the present invention, the electronic device further comprises: a model construction unit for constructing an object under detection model according to a reference model and the multi dimensional coordinate signal with respect to each sensing point of the object under detection, where the object under detection model comprises mass information with respect to each sensing point of the object under detection; and a calculation unit for calculating a force of each sensing point according to the mass information and the acceleration signal of each sensing point.

In a preferable embodiment of the present invention, the host, the plurality of sensors, and the electronic device respectively comprise a communication unit for transmitting data, and the communication unit comprises a Bluetooth unit.

Another object of the present invention is to provide a method for collecting movement-orbits suitable for a movement-orbit sensing system, the movement-orbits collecting method is used for collecting movement-orbits of a plurality of sensing points of an object under detection, comprising steps of: respectively sensing by a plurality of sensors the plurality of sensing points and correspondingly outputting a plurality of sensed signals and a plurality of multi-dimensional coordinate values; receiving by a detection unit the plurality of multi-dimensional coordinate values of the plurality of sensors and correspondingly generating multi-dimensional coordinate signal; receiving and quantizing by an analysis unit the plurality of sensed signals to generate a plurality of sensed values; architecting by a movement-orbit architecture unit the movement-orbit of each sensing point according to the multi-dimensional coordinate signal and the sensed values corresponding to each sensing point of the object under detection; comparing by a comparison unit the movement-orbit of each sensing point of the object under detection with the standard movement-orbit information of the standard database to obtain an offset value; and determining by a determination unit whether the offset value obtained by the comparison unit is greater than a preset value where if the offset value is greater than the preset value, the determination unit determines the movement-orbit of at least one of the sensing points is erroneous, thereby outputting an error signal.

In a preferable embodiment of the present invention, the method further comprises steps of: before respectively sensing by the plurality of sensors the plurality of sensing points and correspondingly outputting the plurality of sensed signals and the plurality of multi-dimensional coordinate values, disposing the plurality of sensors and a host connected therewith on particular locations; and obtaining by a positioning unit absolute position information of the host and an initial relative coordinate value between each sensor and the host, and correspondingly generating by the detection unit the multi-dimensional coordinate signal according to the initial relative coordinate value and the plurality of multi-dimensional coordinate values of each sensor.

In a preferable embodiment of the present invention, the plurality of sensors comprise a gyroscope sensor and an acceleration sensor, and the sensed signals comprise a rotation angle signal and an acceleration signal.

In a preferable embodiment of the present invention, the method further comprises steps of constructing by a model construction unit an object under detection model according to a reference model and the multi-dimensional coordinate signal with respect to each sensing point of the object under detection, where the object under detection model comprises mass information with respect to each sensing point of the object under detection; and calculating by a calculation unit a force of each sensing point according to the mass information and the acceleration signal of each sensing point.

In the present invention, a plurality of physical sensed signals (such as position, speed, acceleration, force, and so on) and a plurality of multi-dimensional coordinate values of a plurality of sensing points of an object under detection are recorded by a plurality of sensors, so as to calculate a movement-orbit of each sensing point, and an object under detection model is constructed according to a reference model and the movement-orbit of each sensing point. In addition, by using a comparison unit to compare the object under detection model of the object under detection with standard movement-orbit information, the present invention can distinctly determine whether the movement-orbits of the object under detection are correct, thereby improving motions of the object under detection to achieve a better movement effect.

### BRIEF DESCRIPTION OF THE DRAWINGS

FIG. 1 depicts a schematic diagram of a movement-orbit sensing system according to a preferable embodiment of the present invention; and

FIG. 2 depicts a flow chart of a method for collecting movement orbits according to a preferable embodiment of the present invention.

### DETAILED DESCRIPTION OF THE INVENTION

These and other features, aspects, and advantages of the present invention will become better understood with regard to the following description, appended claims, and accompanying drawings.

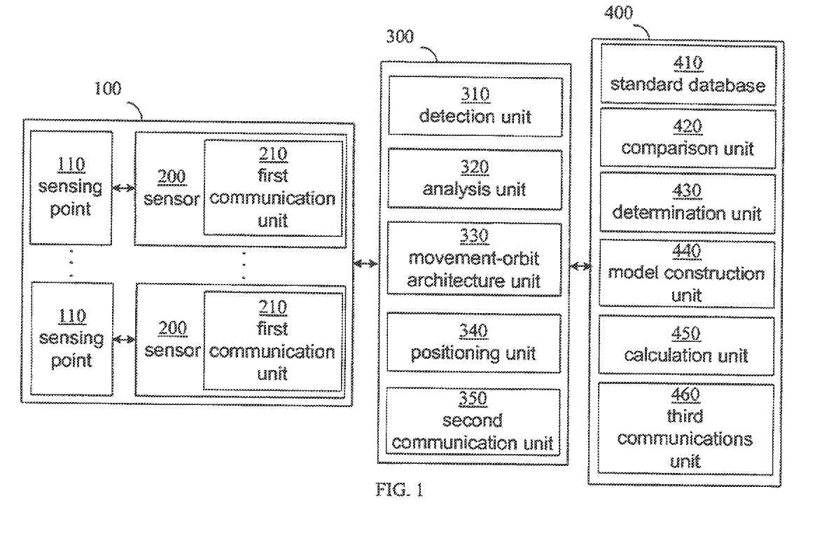

Please refer to FIG. 1, which depicts a schematic diagram of a movement-orbit sensing system according to a preferable embodiment of the present invention. The movement-orbit sensing system comprises a plurality of sensors 200, a host 300, and an electronic device 400. The plurality of sensors 200 are respectively disposed on a plurality of sensing points 110 of an object under detection 100 for respectively sensing movements of the plurality of sensing points 110. Each sensor 200 is provided with a first communication unit 210. The sensors 200 sense the movements of sensing points 110 and then the first communication unit 210 correspondingly outputs a plurality of sensed signals and a plurality of multi-dimensional coordinate. The multi-dimensional coordinate signal comprises x-y-z coordinate information in a three-dimensional space of the sensors 200 and rotation angle information at each time point. The object under detection 100 may be a human, an animal, or various types of precise electronic equipment, such as a robot or an electronic arm. The sensors 200 can be disposed on the plurality of sensing points 110 by using various methods, such as adhesives, wearable, or embedded. The host 300 can be disposed on the object under detection 100 by using a wearable method.

As shown on FIG. 1, the host 300 comprises a detection unit 310, an analysis unit 320, a movement-orbit architecture unit 330, a positioning unit Wand a second communication unit 350. The detection unit 310 is used for receiving the multi-dimensional coordinate values outputted by the sensor 200, thereby correspondingly generating a multi-dimensional coordinate signal. To be more specific, before starting the movement-orbit sensing system of the present invention, the plurality of sensors 200 and the host 300 are disposed on particular locations, then the host 300 is started, and current quantized absolute position information, such as absolute coordinate and height information, are obtained by the positioning unit 340 of the host 300, in this particular location, the relative distance between each sensor 200 and the host 300 is known. Therefore, the positioning unit 340 can not only obtain an initial relative coordinate value between each sensor 200 and the host 300, but can also obtain an initial absolute coordinate value of each sensor 200 according to the absolute position information of the host 300 and the initial relative coordinate value of sensors. Next, the plurality of sensors 200 are started, and the sensors 200 are disposed on the sensing points 110 of the object under detection 100, so as to collect the multi-dimensional coordinate values. The detection unit 310 of the host 300 correspondingly generates the multi-dimensional coordinate signal according to the initial relative coordinate value of each sensor 200 and the plurality of multi-dimensional coordinate values. It should be noted that the positioning unit 340 of the present invention may be an indoor positioning system, so that the movement-orbit sensing system of the present invention will not be restricted by a location where the object under detection 100 is located during use.

The sensed signals outputted by each sensor 200 are analyzed by the analysis unit 320 of the host 300. To be more specific, the sensors 200 of the present invention comprise a gyroscope sensor and an acceleration sensor, and the sensed signals comprise a rotation angle signal and an acceleration signal. In addition, in the sequential of starting the sensors 200, the gyroscope sensor can firstly be started for collecting the multi-dimensional coordinate values at each time point, and then the acceleration sensor is started. The sensed signals are quantized by the analysis unit 320, so as to generate a plurality sensed values.

After correspondingly generating the multi-dimensional coordinate signal and the sensed values, the movement-orbit of each sensing point 110 is architected according to the multi-dimensional coordinate signal and the sensed values corresponding to each sensing point of the object under detection by the movement-orbit architecture unit 330.

As shown in FIG. 1, the electronic device 400 comprises a standard database 410, a comparison unit 420, a determination unit 430, a model construction unit 440, a calculation unit 450 and a third communications unit 460. The standard database 410 is used for providing standard movement-orbit information, which comprises standard physical quantities with respect to each sensing point 110 of the object under detection 100 in the current exercise, The movement-orbit of each sensing point 110 of the object under detection 100 is compared with the standard movement-orbit information of the standard database by the comparison unit 420, so as to obtain an offset value between the standard movement-orbit intimation and the movement-orbit of each sensing point 110 of the object under detection 100. Furthermore, the determination unit 430 determines whether the offset value obtained by the comparison unit 420 is greater than the preset value, which may be a particular value or a range of values pre-inputted by a user. If the offset value is greater than the preset value, the determination unit 430 determines that the movement-orbit of at least one of the sensing points 110 is erroneous, thereby outputting an error signal. The user can immediately correct the current movement-orbit, such as a rotation angle or a moving distance, of this sensing point 110 based upon the error signal.

The sensor 200, the host 300, and the electronic device 300 are wirelessly connected, and they transmit data by respectively using a first communication unit 210, a second communication unit 350, or a third communications unit 460. The first communication unit 210, the second to communication unit 350, and the third communications unit 460 transmit date in a low power consumption manner, such as Bluetooth.

The model construction unit 440 of the electronic device 400 can construct an object under detection model according to a pre-build reference model and the multi-dimensional coordinate signal with respect to each sensing point 110 of the object under detection 100. It should be noted that the reference model can be formed by pre inputting physical quantities (such as mass) with respect to each sensing point 110 of the object under detection 100 and other physical quantities (such as length) with respect to any two of sensing points 110, or formed by pre-inputting basic information (such as species, gender, nationality, age, and so on) with respect to the object under detection 100, and then the reference model is formed according to a biological standard model database which is built by international standards. Therefore, the object under detection model comprises mass information with respect to each sensing point. The calculation unit 450 of the electronic device 400 calculates force of the sensing points 100 according to the mass information and the acceleration signal of each sensing point 100. That is, the comparison unit 420 of the electronic device 400 can not only compare the current position, angle, and acceleration of each sensing point 110 of the object under detection 100, but it can further compare the current force of the sensing point 110, Also, the determination unit 430 determines whether the offset value of the force of each sensing point 110 is greater than a preset value.

On the other hand, the electronic device 400 can be connected with a service cloud platform, so as to transmit data corresponding to the movement-orbits with the objet under detection 100, thereby obtaining a comprehensive information service. Furthermore, by connecting with the service cloud platform, reference model information more conforming to the current species can be obtained when the model construction unit 440 of the electronic device 400 constructs the reference model.

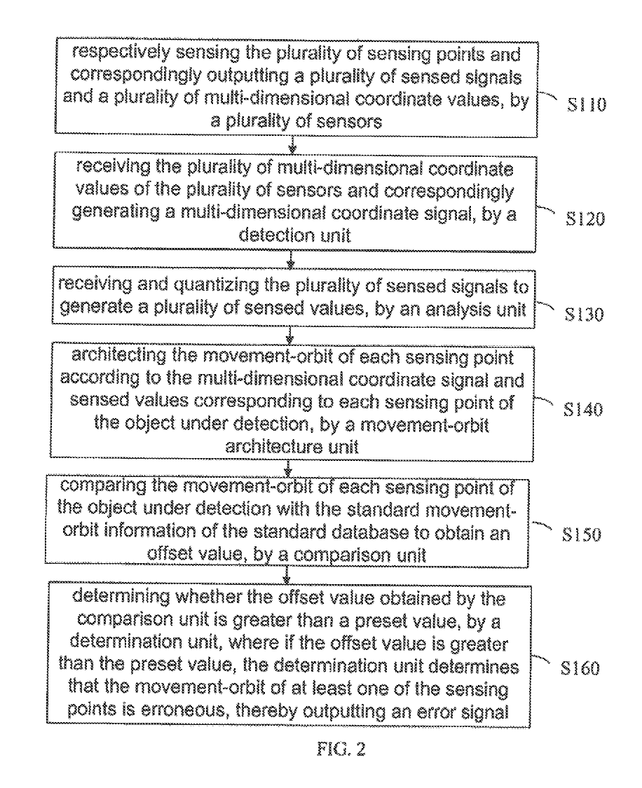

Please refer to FIG. 2, which depicts a flow chart of a method for collecting movement orbits according to a preferable embodiment of the present invention. The method is suitable for the movement-orbit sensing system shown in FIG. 1; it will not be described in further detail here.

Firstly, in step S110, a plurality of sensing points are respectively sensed and then a plurality of sensed signals and a plurality of multi -dimensional coordinate values are outputted by a plurality of sensors.

Next, in step S120, the plurality of multi-dimensional coordinate values of the plurality of sensors are received and then a multi-dimensional coordinate signals is correspondingly generated by a detection unit. To be more specific, the step of obtaining the multi-dimensional coordinate signal further comprises: the plurality of sensors and a host connected therewith are disposed on particular locations, and then absolute position intonation of the host and an initial to relative coordinate value between each sensor and the host are obtained by a positioning unit. The detection unit correspondingly generates the multi-dimensional coordinate signal according to the initial relative coordinate value and the plurality of multi-dimensional coordinate values of each sensor.

Next, in step S130, the plurality of sensed signals are received and quantized by an analysis unit, so as to generate a plurality of sensed values.

Next, in step S140, the movement-orbit of each sensing point is architected according to the multi-dimensional coordinate signal and the sensed values corresponding to each sensing point of the object under detection, by a movement-orbit architecture unit. It should be noted that the plurality of sensors of the present invention comprise a gyroscope sensor and an acceleration sensor for collecting a rotation angle signal and an acceleration signal. Therefore, after generating the multi-dimensional coordinate signal and the sensed values with respect to each sensing point of the object under detection, the method may further comprise steps of constructing by a model construction unit an object under detection model according to a reference model and the multi-dimensional coordinate signal with respect to each sensing point of the object under detection. The object under detection model comprises mass information with respect to each sensing point of the object under detection. Moreover, the calculation unit calculates a force of each sensing point according to the mass information and the acceleration signal.

Next, in step Step S150, the movement-orbit of each sensing point of the object under detection is compared with the standard movement-orbit information of the standard database by a comparison unit to obtain an offset value, It should be noted that the comparison unit can not only compare the current position, angle, and acceleration of each sensing point of the object under detection, but it can further compare the current force of the sensing point.

Next, in step S160, the determination unit determines whether the offset value obtained by the comparison unit is greater than a preset value. If the offset value is greater than the preset value, the determination unit determines that the movement-orbit of at least one of the sensing points is erroneous, thereby outputting an error signal. A user can immediately correct the current movement-orbit, such as a rotation angle or a moving distance, of this sensing point based upon the error signal.

The above descriptions are merely preferable embodiments of the present invention, and are not intended to limit the scope of the present invention. Any modification or replacement made by those skilled in the art without departing from the spirit and principle of the present invention should fall within the protection scope of the present invention. Therefore, the protection scope of the present invention is subject to the appended claims.

What is claimed is:

1. A movement-orbit sensing system for collecting movement-orbits of a plurality of sensing points of an object under detection, comprising:
a plurality of sensors for sensing the plurality of sensing points and correspondingly outputting a plurality of sensed signals and a plurality of multi-dimensional coordinate values;
a host connected with the plurality of sensors, comprising:
a detection unit for receiving the plurality of multi-dimensional coordinate values of the plurality of sensors and correspondingly generating a multi-dimensional coordinate signal;
an analysis unit for receiving and quantizing the plurality of sensed signals to generate a plurality of sensed values; and
a movement-orbit architecture unit for architecting the movement-orbit of each sensing point according to the multi-dimensional coordinate signal and the sensed values corresponding to each sensing point of the object under detection; and
an electronic device connected with the host, comprising:
a standard database having at least one standard movement-orbit information;
a comparison unit for comparing the movement-orbit of each sensing point of the object under detection with the standard movement-orbit intonation of the standard database so as to obtain an offset value; and
a determination unit for determining whether the offset value obtained by the comparison unit is greater than a preset value, wherein if the offset value is greater than the preset value, the determination unit determines the movement-orbit of at least one of the sensing points is erroneous, thereby outputting an error signal.

2. The movement-orbit sensing system according to claim 1, wherein the host further comprises a positioning unit for obtaining an absolute position information of the host and an initial relative coordinate value between each sensor and the host; and the detection unit correspondingly generates the multi-dimensional coordinate signal according to the plurality of multi-dimensional coordinate values and the initial relative coordinate value of each sensor.

3. The movement-orbit sensing system according to claim 1, wherein the plurality of sensors comprise a gyroscope sensor and an acceleration sensor, and the sensed signals comprise a rotation angle signal and an acceleration signal.

4. The movement-orbit sensing system according to claim 3, wherein the electronic device further comprises:
a model construction unit for constructing an object under detection model according to a reference model and the multi-dimensional coordinate signal with respect to each sensing point of the object under detection, wherein the object under detection model comprises a mass information with respect to each sensing point of the object under detection; and
a calculation unit for calculating a force of each sensing point according to the mass information and the acceleration signal of each sensing point.

5. The movement-orbit sensing system according to claim 1, wherein the host, the plurality of sensors, and the electronic device respectively comprise a communication unit for transmitting data, and the communication unit comprises a Bluetooth unit.

6. A method for collecting movement-orbits suitable for a movement-orbit sensing system, the movement-orbits collecting method is used for collecting movement-orbits of a plurality of sensing points of an object under detection, comprising steps of:
respectively sensing the plurality of sensing points and correspondingly outputting a plurality of sensed signals and a plurality of multi-dimensional coordinate values by a plurality of sensors;
receiving the plurality of multi-dimensional coordinate values of the plurality of sensors and correspondingly generating a multi-dimensional coordinate signal by a detection unit;
receiving and quantizing by an analysis unit the plurality of sensed signals to generate a plurality of sensed values;
architecting by a movement-orbit architecture unit the movement-orbit of each sensing point according to the multi-dimensional coordinate signal and the sensed values corresponding to each sensing point of the object under detection;
comparing by a comparison unit the movement-orbit of each sensing point of the object under detection with the standard movement-orbit information of the standard database to obtain an offset value; and
determining by a determination unit whether the offset value obtained by the comparison unit is greater than a preset value, wherein if the offset value is greater than the preset value, the determination unit determines that the movement-orbit of to at least one of the sensing points is erroneous, thereby outputting an error signal.

7. The method for collecting movement-orbits according to claim 6, further comprising steps of: before respectively sensing the plurality of sensing points and correspondingly outputting the plurality of sensed signals and the plurality of multi-dimensional coordinate values by the plurality of sensors, disposing the plurality of sensors and a host connected therewith on particular locations; and
obtaining by a positioning unit an absolute position information of the host and an initial relative coordinate value between each sensor and the host, and correspondingly generating by the detection unit the multi-dimensional coordinate signal according to the initial relative coordinate value and the plurality of multi-dimensional coordinate values of each sensor.

8. The method for collecting movement-orbits according to claim 6, wherein the plurality of sensors comprise a gyroscope sensor and an acceleration sensor, and the sensed signals comprise a rotation angle signal and an acceleration signal.

9. The method for collecting movement-orbits according to claim 8, further comprising steps of: constructing by a model construction unit an object under detection model according to a reference model and the multi-dimensional coordinate signal with respect to each sensing point of the object under detection, wherein the object under detection model comprises a mass information with respect to each sensing point of the object under detection; and
calculating by a calculation unit a force of each sensing point according to the mass information and the acceleration signal of each sensing point.

10. The method for collecting movement-orbits according to claim 6, wherein the host, the plurality of sensors, and the electronic device respectively comprise a communication unit for transmitting data, and the communication unit comprises a Bluetooth unit.

11. A method for collecting movement-orbits suitable for a movement-orbit sensing system, the movement-orbits collecting method is used for collecting movement-orbits of a plurality of sensing points of an object under detection, comprising steps of:
obtaining by a positioning unit an absolute position information of a host and an initial relative coordinate value between a plurality of sensors and the host;
respectively sensing the plurality of sensing points and correspondingly outputting a plurality of sensed signals and a plurality of multi-dimensional coordinate values by the plurality of sensors;
receiving the plurality of multi-dimensional coordinate values of the plurality of sensors and correspondingly generating multi-dimensional coordinate signal according to the initial relative coordinate value and the plurality of multi-dimensional coordinate values of each sensor by a detection unit
receiving and quantizing by an analysis unit the plurality of sensed signals to generate a plurality of sensed values;
architecting by a movement-orbit architecture unit the movement-orbit of each sensing point according to the multi-dimensional coordinate signal and the sensed values;
comparing by a comparison unit he movement-orbit of each sensing point of the object under detection with the standard movement-orbit information of the standard database to obtain an offset value; and
determining by a determination unit whether the offset value obtained by the comparison unit is greater than a preset value, wherein if the oft value is greater than the preset value, the determination unit determines that the movement-orbit of at least one of the sensing points is erroneous, thereby outputting an error signal.

12. The method for collecting movement-orbit according to claim 11, further comprising step of: before obtaining by the positioning unit the absolute position information of the host and the initial relative coordinate value between the plurality of sensors and the host, disposing the plurality of sensors and the host connected therewith on particular locations.

13. The method for collecting movement-orbits according to claim 11, wherein the plurality of sensors comprise a gyroscope sensor and an acceleration sensor, and the sensed signals comprise a rotation angle signal and an acceleration signal.

14. The method for collecting movement-orbits according to claim 13, further comprising steps of: constructing by a model construction unit an object under detection model according to a reference model and the multi-dimensional coordinate signal with respect to each sensing point of the object under detection, wherein the object under detection model comprises a mass information with respect to each sensing point of the object under detection; and
calculating by a calculation unit a force of each sensing point according to the mass information and the acceleration signal of each sensing point.

15. The method for collecting movement-orbits according to claim 11, wherein the host, the plurality of sensors, and the electronic device respectively comprise a communication unit for transmitting data, and the communication unit comprises a Bluetooth unit.
